(19) United States
(12) Patent Application Publication
(10) Pub. No.: US 2004/0055900 A1
(43) Pub. Date: Mar. 25, 2004

(54) Apparatus and methods for sampling and analyzing inlet air associated with combustion turbine

(75) Inventors: Eugene E. Smeltzer, Export, PA (US); Brian D. Ottinger, Pittsburgh, PA (US); Mary Anne Alvin, Pittsburgh, PA (US)

Correspondence Address: Siemens Corporation, Intellectual Property Department, 186 Wood Avenue South, Iselin, NJ, 08830, US

(73) Assignee: Siemens Westinghouse Power Corporation

(21) Appl. No.: 10/252,214

(22) Filed: Sep. 23, 2002

(51) Int. Cl. G01N 27/26

(52) U.S. Cl. 205/784.5; 204/431

(57) ABSTRACT

An apparatus 20 may include a generator 22 and a combustion turbine 24 for driving the generator, the combustion turbine having an air inlet 40 for receiving an inlet air flow. The apparatus may also include an inlet air flow sampling sensor 26. The inlet air flow sampling sensor 26, in turn, may include a solution container 46 for containing a solution 50 for sampled air from the inlet air flow. The inlet air flow sampling sensor 26 additionally may include sensing circuitry for sensing at least one dissolved material in the solution 50. For example, the material may be salt, such as found in the inlet air for coastal power plants.

### FIELD OF THE INVENTION

The present invention relates to the field of combustion turbines, and, more particularly, to sensors for combustion turbines.

### BACKGROUND OF THE INVENTION

Combustion turbines are used to power a wide variety of equipment, including ships, aircraft, and power generators. For example, a typical electrical generator includes a stator and a rotor that turns within the stator to generate electrical power. To drive the rotor, a shaft is connected to a combustion turbine, and the combustion turbine drives the shaft.

In a conventional configuration, the combustion turbine comprises a compressor to draw in and compress a gas, a combustor or heat source to add energy in the form of heat to the compressed gas, and a turbine to extract power from the heated gas. In an electrical generator, the extracted power is used to drive the shaft, which, as already noted, rotates the rotor within the stator to thus generate electricity.

The gas used in the combustion turbine is usually ambient air drawn from the surrounding environment. Although combustion turbine generators provide many advantages in terms of efficiency and reliability as compared to many other types of machines, the use of ambient air can be problematic depending on the nature of the environment in which the combustion turbine is operated. As observed in U.S. Pat. No. 4,060,001 to Archerd, for example, a combustion turbine near a body of seawater is susceptible to the corrosive effects of salt carried by the air drawn into the combustion turbine. This, then, would be a problem with combustion turbines used, for example, to power a ship or a power generator located near a seacoast.

A filter may be installed upstream of an inlet to the combustion turbine, but if saltwater mist, for example, saturates the filter, then salt particles can migrate through the filter media and enter the combustion turbine. Similarly, if salt builds up over time on the filter, then, again, the salt may enter the combustion turbine by migrating through the filter.

The Archerd patent cited above discloses an isokinetic sampling nozzle attached to a flow amplifier that utilizes the Coanada wall attachment effect for capturing samples of ambient air. The sampled air can be analyzed to determine whether there are contaminants in the ambient air.

European Pat. 384392 to Forfitt et al., discloses electrostatic probes that connect to the combustion chamber of a combustion turbine and that supply signals to a processor. The processor processes signals from the probes indicating the occurrence of certain events in the combustion turbine, including the intake of debris such as stones, sand, or salt that carry electrostatic charges.

Notwithstanding the availability of isokinetic sampling and electrostatic charge detection, difficulties remain with respect to monitoring the intake of contaminating materials into a combustion turbine power generator. For example, because salt can exist as a dissolved solid in a liquid droplet, or as a very fine particle left after the water evaporates, it may be difficult to effectively or efficiently measure salt in an inlet air flow to the combustion turbine.

### SUMMARY OF THE INVENTION

In view of the foregoing background, it is therefore an object of the present invention to provide effective and efficient sampling and analyzing of inlet air drawn from the inlet air flow received into a combustion turbine.

This and other objects, features, and advantages in accordance with the present invention are provided by an inlet air flow sampling sensor comprising a solution container and sensing circuitry associated therewith. The solution container may contain a solution through which sampled air is passed. Accordingly, materials from the sampled air may be extracted and dissolved in the solution. The sensing circuitry may sense at least one dissolved material in the solution, such as salt, for example. The sampling is thus accurate, and can be efficiently used in a continuous operating mode, for example.

The sensing circuitry may comprise at least one ion-selective electrode that can be immersed in the solution. The sensing circuitry also may comprise a reader connected to the ion-selective electrode. The reader may display a concentration of the selected material, such as salt.

The sensing circuitry may further comprise a data logger connected to the reader. The data logger may log data based on the signals generated by the ion-selective electrode. Additionally, the sensing circuitry may comprise a data analyzer connected to the reader either directly or through the data logger. The data analyzer may provide analysis, extrapolate trends, or generate predictions based on the data logged by the logger.

The at least one ion-selective electrode and the reader, moreover, may be for dissolved salt. Accordingly, the sensing circuitry may determine, with respect to the sampled air from the inlet air flow, that salt is being carried by the inlet air flow and in what amount. Other contaminants can be similarly measured and monitored. The amount of contaminants affecting the combustion turbine, accordingly, can be measured and recorded over time.

The inlet air flow sampling sensor may additionally comprise a sampling probe. The sampling probe may be connected to be in fluid communication with and between the inlet air flow and the solution container. More particularly, the sampling probe may comprise an isokinetic sampling probe for greater sampling accuracy. The sampling probe may advantageously continuously sample the inlet air flow during operation of the combustion turbine. The apparatus may also typically include an inlet air filter, in which event, the inlet air flow sampling sensor may be downstream from the inlet air filter.

An additional aspect of the invention relates to a method for sampling an inlet air flow for a combustion turbine. The method may comprise passing sampled air from the inlet air flow through a solution to dissolve materials from the sampled air in the solution, and sensing at least one dissolved material therein using sensing circuitry.

### BRIEF DESCRIPTION OF THE DRAWINGS

FIG. 1 is a schematic view of an apparatus according to the present invention.

FIG. 2 is a more detailed schematic view of the inlet air flow sampling sensor of the apparatus of FIG. 1.

FIG. 3 is a flow diagram of a method according to the present invention.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

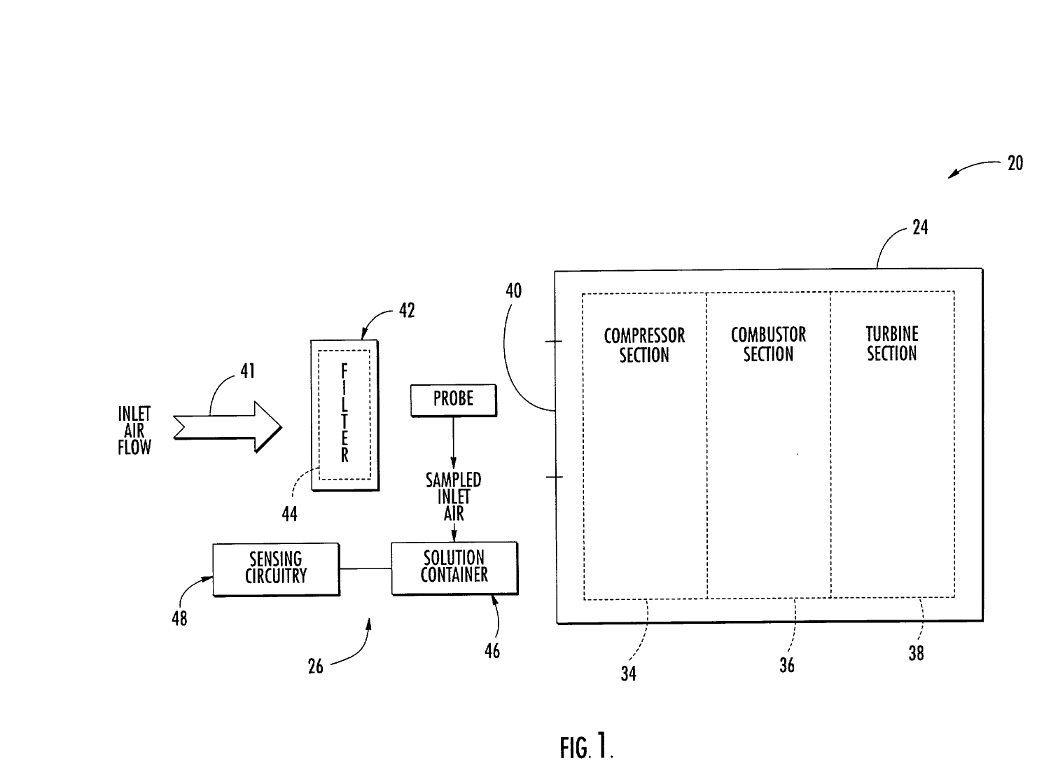

Referring initially to FIG. 1, an apparatus 20 according to the present invention is described. Illustratively, the apparatus includes a combustion turbine 24 that can be used to mechanically power other equipment and machinery and an inlet air flow sampling sensor 26 for detecting and measuring the concentration of contaminating materials in an inlet air flow 41 received by the combustion turbine.

The combustion turbine 24 illustratively comprises a compressor section 34, a combustor section 36 downstream from the compressor section, and a turbine section 38 downstream from the combustor section. As will be readily understood by those skilled in the art, the inlet air flow 41 is received into the compressor section 34 through an air inlet 40. The inlet air is compressed and fuel is added to it in the combustor section 36 to thereby power the turbine section 38, as will also be readily understood by those skilled in the art.

Contaminating materials, of course, can be carried by the inlet air flow 41 into the combustion turbine 24. For example, if the combustion turbine 24 were operated at sea or near a coastline, there would be a possibility that saltwater mist would mix with the inlet air flow 41 and be carried into the combustion turbine 24. Accordingly, as illustrated, a filter housing 42 with a filter 44 carried therein is positioned upstream from the air inlet 40 of the combustion turbine 24 to filter contaminating materials from the inlet air flow 41.

Despite the presence of the filter 44, contaminating materials may yet reach the combustion turbine 24. For example, if saltwater saturates the filter 44, salt may migrate through the filter media and enter the combustion turbine 24. Likewise, if over time, salt builds up on the filter 44, it may also reach the combustion turbine 24. One skilled in the art will readily appreciate that other contaminating materials can also enter the combustion turbine 24 in a similar manner. Contaminating materials such as salt, for example, are known to cause corrosion of the internal components of the combustion turbine 24. It is therefore advisable to monitor the inlet air flow 41 to determine whether and to what extent contaminating materials may be entering the combustion turbine 24 borne by the inlet air flow 41 and received through the air inlet 40.

The determinations can be used to decide whether the filter 44 is functioning properly or whether it ought to be serviced or replaced. They can also be used in calculating how soon and/or how often maintenance (e.g., replacement of the filter) should be performed. Maintenance, accordingly, can be scheduled in advance. As discussed more fully below, the nature and amount of contaminants to which the combustion turbine 24 has been subjected may be recorded over time for analysis of their cumulative effect on the combustion turbine 24. The determinations and analysis are facilitated by inclusion in the apparatus 20 of the inlet air flow sampling sensor 26, which is illustratively positioned downstream from the inlet air filter 44.

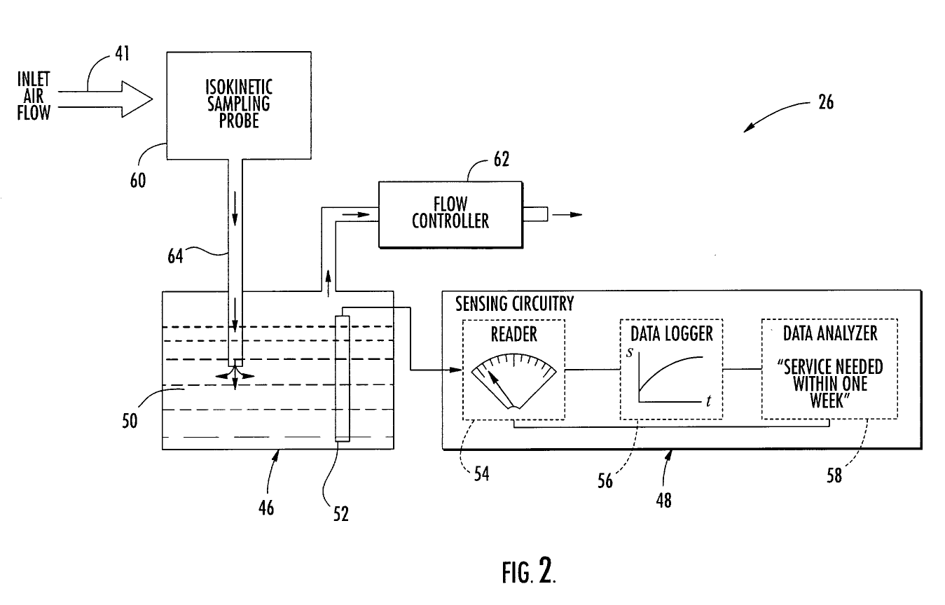

Referring additionally now to FIG. 2, the inlet air flow sampling sensor 26 illustratively comprises a solution container 46 and, associated therewith, sensing circuitry 48. A solution 50 may be contained in the solution container 46, and sampled air drawn from the inlet air flow 41 may be introduced into or passed through the solution 50 so that materials carried by the sampled air may be dissolved in the solution, as will be readily understood by those skilled in the art. For example, sampled air may be passed through the solution 50 by bubbling the air into the solution.

The sensing circuitry 48 senses at least one material dissolved in the solution. For example, if the inlet air flow 41 carries salt, then when the sampled air is passed through the solution 50, such as water, the salt is dissolved in the water. Dissolved in the water, the salt yields sodium and chloride ions, as will be readily understood by those skilled in the art. Accordingly, the sensing circuitry 48 may sense for one or both of sodium and chloride ions.

In the embodiment illustrated in FIG. 2, the sensing circuitry 48 further comprises an ion-selective electrode 52. The ion-selective electrode 52 may be immersed in the solution 50 contained in the solution container 46. The ion-selective electrode 52, as will be readily understood by one skilled in the art, can generate an electrical signal in response to the presence of a particular ion. The signal, moreover, may be a function of the concentration of the ion in the solution 50, as will also be readily appreciated by those skilled in the art.

Thus, referring again to the earlier example, if salt is dissolved in the solution 50, which, again, may comprise water, then the ion-selective electrode 52 can provide a signal indicating the concentration of sodium and/or chloride ions in the water. As will be readily appreciated by those skilled in the art, additional ion-selective electrodes can be added as desired to indicate the presence and concentration of various different contaminating materials and their ions.

The ion concentration of the solution 50, moreover, reflects an amount of corresponding material borne by the inlet air flow 41, as will be readily appreciated by those skilled in the art. It, therefore, can be used to assess the amount of a contaminating material entering the combustion turbine 24.

The sensing circuitry 48 also illustratively comprises a reader 54 connected to the ion-selective electrode 52 for providing a conveniently read indication of the presence and/or concentration of a contaminating material. The reader 54 may be a simple meter that gives, for example, a voltage or current reading commensurate with the concentration of a particular ion in the solution 50. Alternatively, the reader 54 may comprise a more complex processor specifically programmed for such readings. Still further, the reader 54 alternately may be a processor associated with a general-purpose, programmable computer, as will be readily understood by those skilled in the art.

The sensing circuitry 48 further illustratively comprises a data logger 56 connected to the reader 54. The data logger 56 may be a discrete circuit dedicated to logging readings generated by the reader 54, or, alternately, it may be a register or memory associated with a general-purpose, programmable computer and for storing data generated by a processor, as will, again, be readily understood by those skilled in the art. Additionally, or alternatively, the sensing circuitry 48 may comprise an engine-trip or shut-down circuit to shut down the combustion turbine 24 in response to detection of a particular contaminating material or particular amount thereof.

The sensing circuitry 48 also illustratively comprises a data analyzer 58 connected directly or through the data logger 56 to the reader 54. As with both the reader 54 and the data logger 56, the data analyzer 58 may be a discrete circuit for performing a specific analysis. Alternatively, however, the data analyzer 58 may be hardware and/or software associated with a general-purpose, programmable computer.

Accordingly, the sensing circuitry 48 can read signals and record data derived from the sampled air drawn from the inlet air flow 41. The data can be analyzed, trends extracted therefrom, and assessments made as to whether and to what extent contaminating materials are reaching the air inlet 40 of the combustion turbine 24. Decisions can then be made as to what, if any, corrective steps need to be taken. Moreover, such analyses can be performed substantially continuously and in near real-time without taking a sample to a laboratory and waiting for the return of results before making any further calculations.

To efficiently acquire the sampled air from the inlet air flow 41, the apparatus 20 illustratively includes a sampling probe 60. The sampling probe 60 is connected to be in fluid communication with and between the inlet air flow 41 and the solution container 46 to thereby convey the sampled air to the solution 50 contained therein. So that the above-described analyses and determinations can be made as desired and without interruption to the operation of the combustion turbine 24, the sampling probe 60 can sample the inlet air flow 41 during operation of the combustion turbine 24.

In the embodiment shown in FIG. 2, the sampling probe 60 is illustratively an isokinetic sampling probe. The sampling probe 60 thus measures the velocity of the inlet air flow and, illustratively using the flow controller 62, adjusts the rate at which sampled air is drawn from the inlet air flow. Sampled air is illustratively drawn through a tube 64 and into the solution container 46 where it passes through the solution 50 before exiting the solution container under the control of the flow controller 62. The sampling probe 60, by controlling the flow of the sampled air based on the velocity of the inlet air flow 41, thus helps ensure that the sample drawn gives an accurate representation of the material that may be contained in the inlet air flow, as will be readily understood by those skilled in the art.

Positioned downstream from the filter 44, the sampling probe 60 provides a sample from which some material or particulates have already been extracted. This yields, therefore, a sample that likely reflects the concentration of materials or particulates in the inlet air flow 41 carried to the air inlet 40 of the combustion turbine 24.

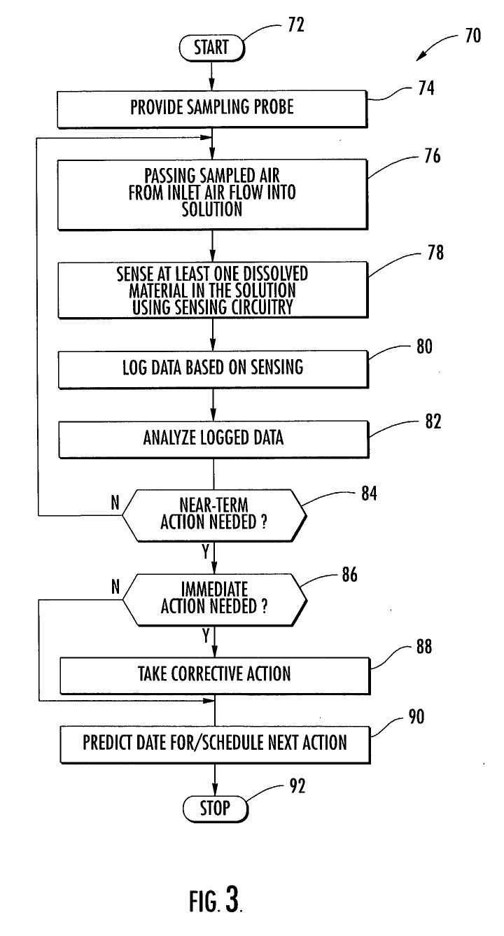

An additional aspect of the invention relates to a method for sampling an inlet air flow 41 for a combustion turbine 24. Referring to the flow diagram 70 of FIG. 3, the method comprises providing a sampling probe 60 for acquiring sampled air from the inlet air flow 41 (Block 74) after the start at Block 72. At Block 76, the sampled air from the inlet air flow is passed into a solution 50, and materials from the sampled air are dissolved in the solution. The solution 50, at Block 78, is sensed for at least one dissolved material using sensing circuitry 48.

Data based on the sensing is logged at Block 80, and the data is analyzed at Block 82. Based on the analysis of the logged data, a determination is made as to whether corrective action is needed (Block 84). The corrective action may, for example, entail replacing the filter 44 used to prevent salt and/or other contaminant materials from entering the combustion turbine 24. Replacement may be required if, for example, the filter 44 has become so saturated that if is not effectively filtering contaminate material from the inlet air flow 41 any longer.

If no corrective action is needed, then the sampling probe 60 continues to sample the inlet air flow 41 while the combustion turbine 24 is operated. Based on the analysis of the logged data, however, it may be determined that some corrective action is needed. If so, a determination is made whether near-term action is needed (Block 86). If near-term action is not needed, then, based on the logged data, a date for when the action will be needed is estimated, and the action is appropriately scheduled (Block 90). Otherwise, the corrective action (e.g., replacement of filter 44) is taken at Block 88.

Many modifications and other embodiments of the invention will come to the mind of one skilled in the art having the benefit of the teachings presented in the foregoing descriptions and the associated drawings. Therefore, it is to be understood that the invention is not to be limited to the specific embodiments disclosed, and that modifications and embodiments are intended to be included within the scope of the appended claims.

That which is claimed is:

1. An apparatus comprising:
a combustion turbine having an air inlet for receiving an inlet air flow; and
an inlet air flow sampling sensor comprising
a solution container for containing a solution for sampled air from the inlet air flow, and
sensing circuitry for sensing at least one dissolved material in the solution.

2. An apparatus according to claim 1 wherein said sensing circuitry comprises at least one ion-selective electrode for immersion in the solution, and a reader connected to said at least one ion-selective electrode.

3. An apparatus according to claim 2 wherein said sensing circuitry further comprises a data logger connected to said reader.

4. An apparatus according to claim 2 wherein said sensing circuitry further comprises a data analyzer connected to said reader.

5. An apparatus according to claim 2 wherein said at least one ion-selective electrode and said reader are for dissolved salt.

6. An apparatus according to claim 1 wherein said inlet air flow sampling sensor further comprises a sampling probe connected in fluid communication between the inlet air flow and said solution container.

7. An apparatus according to claim 6 wherein said sampling probe comprises an isokinetic sampling probe.

8. An apparatus according to claim 6 wherein said sampling probe continuously samples the inlet air flow during operation of said combustion turbine.

9. An apparatus according to claim 1 further comprising an inlet air filter, and wherein said inlet air flow sampling sensor is downstream from said inlet air filter.

10. An inlet air flow sampling sensor for a combustion turbine comprising:
a solution container for containing a solution for sampled air from the inlet air flow; and
sensing circuitry for sensing at least one dissolved material in the solution.

11. An inlet air flow sampling sensor according to claim 10 wherein said sensing circuitry comprises at least one ion-selective electrode for immersion in the solution, and a reader connected to said at least one ion-selective electrode.

12. An inlet air flow sampling sensor according to claim 10 wherein said sensing circuitry further comprises a data logger connected to said reader.

13. An inlet air flow sampling sensor according to claim 10 wherein said sensing circuitry further comprises a data analyzer connected to said reader.

14. An inlet air flow sampling sensor according to claim 11 wherein said at least one ion-selective electrode and said reader are for dissolved salt.

15. An inlet air flow sampling sensor according to claim 10 further comprising a sampling probe connected in fluid communication between the inlet air flow and said solution container.

16. An inlet air flow sampling sensor according to claim 15 wherein said sampling probe comprises an isokinetic sampling probe.

17. An inlet air flow sampling sensor according to claim 15 wherein said sampling probe continuously samples the inlet air flow during operation of the combustion turbine.

18. A method for sampling an inlet air flow for a combustion turbine comprising:
passing sampled air from the inlet air flow into a solution; and
sensing at least one dissolved material in the solution using sensing circuitry.

19. A method according to claim 18 wherein the sensing circuitry comprises at least one ion-selective electrode for immersion in the solution, and a reader connected thereto.

20. A method according to claim 18 further comprising logging data from the sensing.

21. A method according to claim 18 further comprising analyzing data from the sensing.

22. A method according to claim 18 wherein the sensing is for dissolved salt.

23. A method according to claim 18 further comprising providing a sampling probe connected in fluid communication between the inlet air flow and the solution.

24. A method according to claim 23 wherein the sampling probe comprises an isokinetic sampling probe.

25. A method according to claim 23 wherein the sampling probe continuously samples the inlet air flow during operation of the combustion turbine.
